(19) United States
(12) Patent Application Publication
(10) Pub. No.: US 2016/0314654 A1
(43) Pub. Date: Oct. 27, 2016

(54) Method, Game Server and Computer Program Product for Conducting a Multi-Level Tournament

(71) Applicant: Shingfung LO, Macau (MO)

(72) Inventor: Shingfung LO, Macau (MO)

(21) Appl. No.: 14/695,781

(22) Filed: Apr. 24, 2015

(51) Int. Cl. G07F 17/32

(52) U.S. Cl. CPC G07F 17/3248

(57) ABSTRACT

A method for conducting a multi-level tournament includes acquiring a player's profile from a database in response to the player entering the multi-level tournament. The player can conduct a first level game in response to the player having the first game level. The player's chip amount is changed from a first chip amount to a second chip amount according to a result of the first level game. The player's game level is changed from the first game level to a second game level in response to the second chip amount meeting a predetermined condition and enabling the player to exit the first level game and to conduct a second level game in response to the player's game level being changed from the first game level to the second game level.

### FIELD OF THE INVENTION

Embodiments of the present application relate generally to a multi-level tournament, and more particularly, to a method, a game server and a computer program product for conducting a multi-level tournament.

### BACKGROUND ART

Poker games' popularity has been surging since 2000s particularly due to widely televised main events of the World Series of Poker (WSOP), the World Poker Tour (WPT), the European Poker Tour (EPT), the Asia Pacific Poker Tour (APPT), and so on.

During this time, poker games have been developed from traditional single table games into modern tournaments such as single-table Tournaments (STT) and Multi-table Tournaments (MTT). A STT is also referred to as a Sit-and-Go (SNG) tournament which is a poker tournament with no scheduled starting time that starts whenever the necessary players have put up their money. A MTT involves many players playing simultaneously at dozens or even hundreds of tables. In MTT, the number of players at each table is kept even by moving players, either by switching one player or (as the field shrinks) taking an entire table out of play and distributing its players amongst the remaining tables.

All of the above-mentioned tournaments have been around for many years, thus there is a demand for developing a new type of tournament which is exciting, uncomplicated and easy to learn so as to keep enticing players to play.

### SUMMARY OF THE INVENTION

In order to solve the above problem, embodiments of the present application aim at providing a method, a game server and a computer program product for conducting a multi-level tournament.

One embodiment of the present application provides a method for conducting a multi-level tournament performed by a game server, comprising: acquiring a player's profile from a database in response to said player entering said multi-level tournament, said profile indicating at least that said player has a first game level and a first chip amount; enabling said player to conduct a first level game in response to said player having said first game level, said first level game being conducted among a plurality of players having said first game level; changing said player's chip amount from said first chip amount to a second chip amount according to a result of said first level game; changing said player's game level from said first game level to a second game level in response to said second chip amount meeting a predetermined condition; and enabling said player to exit said first level game and to conduct a second level game in response to said player's game level being changed from said first game level to said second game level.

Another embodiment of the present application provides a game server for conducting a multi-level tournament, comprising at least a processor operating in conjunction with a memory and a plurality of units, which units comprising: a profile acquiring unit for acquiring a player's profile from a database in response to said player entering said multi-level tournament, said profile indicating at least that said player has a first game level and a first chip amount; a game conducting unit for enabling said player to conduct a first level game in response to said player having said first game level, said first level game being conducted among a plurality of players having said first game level; a first chip changing unit for changing said player's chip amount from said first chip amount to a second chip amount according to a result of said first level game; a first level changing unit for changing said player's game level from said first game level to a second game level in response to said second chip amount meeting a predetermined condition; and a game changing unit for enabling said player to exit said first level game and to conduct a second level game in response to said player's game level being changed from said first game level to said second game level.

Yet another embodiment of the present application provides a computer program product comprising program codes for performing the following steps when the computer program codes are executed on one or more computing devices: acquiring a player's profile from a database in response to said player entering said multi-level tournament, said profile indicating at least that said player has a first game level and a first chip amount; enabling said player to conduct a first level game in response to said player having said first game level, said first level game being conducted among a plurality of players having said first game level; changing said player's chip amount from said first chip amount to a second chip amount according to a result of said first level game; changing said player's game level from said first game level to a second game level in response to said second chip amount meeting a predetermined condition; and enabling said player to exit said first level game and to conduct a second level game in response to said player's game level being changed from said first game level to said second game level.

In one embodiment, the computer program product may be stored on a computer readable recording medium.

The method for conducting a multi-level tournament according to embodiments of the present application may be carried out “in real life,” such as at a casino, with physical tables, cards, chips, etc. Additionally or alternatively, the method may also be operable on one or more computers, such as a plurality of computers connected via an internet connection with each computer running a resident copy of substantially similar software or remotely running web-based software.

### BRIEF DESCRIPTION OF DRAWINGS

The above and other objects, features and advantages of the present application will become more apparent from the following description of some embodiments of the present application with reference to the accompanying drawings, in which the same reference number generally refers to the same component throughout the embodiments of the present application.

FIG. 1 is a flowchart depicting a method for conducting a multi-level tournament according to one embodiment of the present application.

FIG. 2 is a schematic diagram showing an overall architecture of a multi-level tournament according to a particular example of one embodiment of the present application.

FIG. 3 is a schematic diagram showing rules specified for each level of game in the multi-level tournament according to the particular example of one embodiment of the present application.

FIG. 4 is a flowchart depicting a method for conducting the multi-level tournament according to the particular example of one embodiment of the present application.

FIG. 5 is a block diagram depicting an apparatus for conducting a multi-level tournament according to one embodiment of the present application.

FIG. 6 is a block diagram depicting an exemplary computer system/game server which is applicable to implement the embodiments of the present application.

### DESCRIPTION OF EMBODIMENTS

Some preferable embodiments will be described in more detail with reference to the accompanying drawings. However, the present application can be implemented in various manners, and thus should not be construed to be limited to the embodiments disclosed herein. On the contrary, those embodiments are provided for the thorough and complete understanding of the present application, and completely conveying the scope of the present application to those skilled in the art.

Embodiments of the present application provide a multi-level tournament including a plurality of levels of games respectively for players with different game levels. In one embodiment, a player may play games with other players who have the same level as his/hers. As the games progress, a player may get more chips by defeating others or get fewer chips by being defeated by others. After a few rounds, a player may be promoted to a higher level game to play with players with higher game levels if the player has been constantly winning. In contrast, a player may be demoted to a lower level game to play with players with lower game levels if the player has been constantly losing.

In different embodiments, a variety of games such as board games, card games, and the like may be adopted in the multi-level tournament. For example, players may play poker games including Texas hold'em, Seven Card Stud, Low-Ball, Omaha and Draw Poker, etc. or board games including chess, go, checkers, etc. in the multi-level tournament.

In addition to the rules or variations described herein, the game may generally follow the accepted rules used before. Still taking poker games for example, each hand may be played according to the rules of Texas hold'em, Omaha, 5 Card Stud, 7 Card Stud, Draw, etc. depending on which poker game is being played. For example, if Texas hold'em is played, for each hand, one player may be a big blind and another may be a small blind. Each player seated at the table may receive two hole cards dealt face down. Three community cards may be dealt face up, followed by a single turn card and then a single river card. In addition, there may be a round of betting before the community cards are dealt, after they are dealt, and after the turn and river. At each stage, players have the opportunity to bet, to check, or to fold. After final bets are made, all remaining players may show their cards in order (unless they fold), moving from the left of the dealer, and the player or players with the strongest hand win the pot. In no-limit versions, players may go “all-in” and bet all of their chips. Players that win these hands have the opportunity to increase their chip amounts significantly, but players that lose these hands lose all of their chips or may be even eliminated.

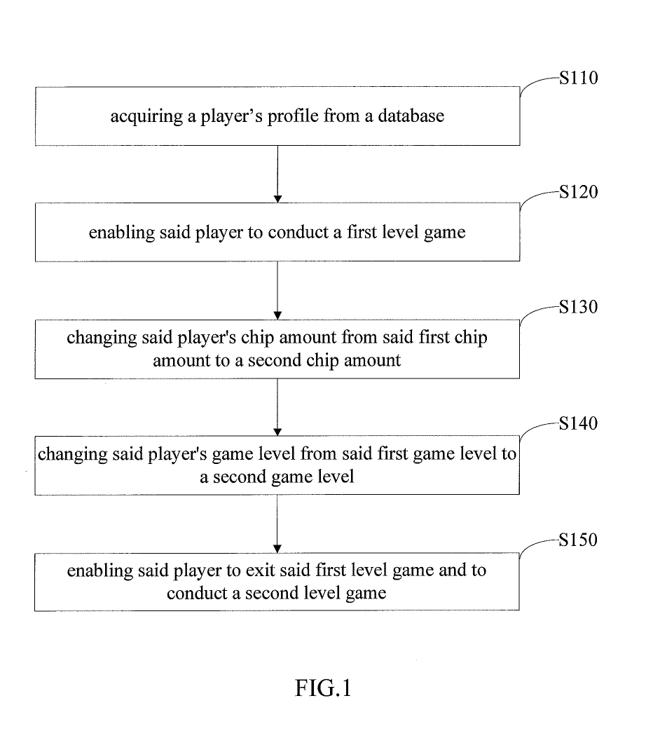

Hereinafter, a method for conducting a multi-level tournament according to an embodiment of the present application will be described with reference to FIG. 1.

FIG. 1 is a flowchart depicting a method for conducting a multi-level tournament according to one embodiment of the present application.

As shown in FIG. 1, the method for conducting a multi-level tournament may include: in step S110, acquiring a player's profile from a database in response to the player entering the multi-level tournament, the profile indicating at least that the player has a first game level and a first chip amount; in step S120, enabling the player to conduct a first level game in response to the player having the first game level, the first level game being conducted among a plurality of players having the first game level; in step S130, changing the player's chip amount from the first chip amount to a second chip amount according to a result of the first level game; in step S140, changing the player's game level from the first game level to a second game level in response to the second chip amount meeting a predetermined condition; and in step S150, enabling the player to exit the first level game and to conduct a second level game in response to the player's game level being changed from the first game level to the second game level.

The second level game may be a continuation of the first level game. For example, although the players may be reseated, blind levels and antes may be altered, etc., the players promoted from the first level game may start the second level game with substantially the same chip amounts or as they have when their promotion are triggered.

Below, the multi-level tournament conducting method and these steps will be described in more detail.

In one embodiment, in order to implement the multi-level tournament, each player may be assigned with a certain game level and a certain chip amount. For example, a player's game level and chip amount may be recorded in his/her profile. The profile may be created when the player joins the multi-level tournament for the first time and then be stored in a database for future uses.

To this end, in one embodiment, before step S110, the method for conducting a multi-level tournament may further include: receiving a request for entering the multi-level tournament from a new player; and initializing the new player's profile according to the request so that the new player has an initial game level and an initial chip amount.

In one embodiment, in order to keep the justice in competition, the initial game level and the initial chip amount assigned to each new player and recorded in his/her profile may be the same, e.g., Level-1 (i.e., the lowest level in the multi-level tournament) and 1,000 chips. However, the present application is not limited to this.

For example, depending on a different system design, different initial game levels and initial chip amounts may be allocated to new players if they pay different buy-in amounts. In particular, a player may be initialized as a Level-1 player if he/she does not pay any money to get extra chips at the time of registration; while a player may initialized as a Level-2 player if he/she pays money to get 10,000 chips at the time of registration.

Then, when a player wants to conduct the multi-level tournament, in step S110, his/her profile is loaded from the database if the player is an existing user, or his/her profile is created and stored into the database if this is the first time that the player enters the tournament. By reading the player's profile, it can be known which game level he/she is currently in and how many chips he/she has. For ease of description, assume that the play is in a first game level and has a first chip amount.

It should be noted that the first game level does not always mean a beginning level of the tournament (which is referred to as Level-1, the lowest level, or the initial level in the description), but only means a certain level (e.g., Level-1, Level-2, Level-3, etc.); and similarly, the second game level does not always mean the level which is one level higher than the beginning level (which is referred to as Level-2 in the description), but only means a certain level which may be different from the first level or the first level itself in some occasion.

Next, in step S120, based on the fact that the player is a first-game-level player, he/she is allowed to conduct a first level game with some other first-game-level player (players). Since there may be a limit on the number of players who are playing at the same time depending on what kind of game is involved in the multi-level tournament, it needs to be decided which game venue still has unoccupied place for the first-game-level player to sit and play.

To this end, in one embodiment, step S120 may include: checking whether an unoccupied place exists in an existing game venue for the first level game; adding the player into the existing game venue in response to the unoccupied place existing; and in response to the unoccupied place not existing, creating a new game venue for the first level game and adding the player into the new game venue.

In particular, there may be a plurality of places (e.g., seats) in a game venue (e.g., a game table), and the number of these places may be equal to the maximum number of players allowed in the involved game. The player who just comes in may be assigned to a game venue with at least one free place or with the fewest players in this level of game. If all places are taken in each of the existing game venues, the player may be assigned to a newly-created game venue and wait for enough players to show up.

When all places in a game venue are taken or when there are enough players in that game venue, the players can play the involved game with each other. Then, in step 130, the first-game-level player may win chips from or lose chips to other players according to a result of every round of the first level game.

In one embodiment, the involved game may be a wagering game in which players are allowed to wager.

In this case, step S130 may include: enabling the player to wager in the first level game; and changing the player's chip amount from the first chip amount to a second chip amount according to the rule of the first level game, how all players in the first level game wager, and whether the player wins or loses the first level game.

An example of the wagering game is Texas hold'em which is normally played using small and big blind bets (i.e., forced bets) by two players, and antes (forced contributions by all players) may be used in addition to blinds.

Alternatively, the involved game may also be a game without wagering. Then, the player's chip amount may vary depending on whether he/she wins or loses the first level game or to what extent he/she wins or loses the game.

In either case, the first-game-level player's chip amount may be constantly increased or diminished during the game time. Depending on how much the first-game-level player's chip amount varies, he/she may be promoted to a higher level game, demoted to a lower level game, or kept in the same level game.

In the first case, in one embodiment, step S140 may include: determining whether the first game level is a final game level in response to the second chip amount being equal to or more than a first threshold amount; and promoting the player's game level from the first game level to the second game level in response to the first game level being not the final game level, the second game level is one level higher than the first game level.

That is to say, if it is determined that the first game level is not the highest game level in the multi-level tournament, and if the first-game-level player's chip amount reaches or exceeds an upper limit, he/she may be promoted to become a higher-game-level player. For example, a Level-1 player may be promoted to be a Level-2 player or even a higher level player in some rare occasion (for example, the Level-1 player may skip Level-2 and directly become a Level-3 player if he/she wins so many chips in one round that his/her chip amount goes directly beyond the threshold amount for promotion to Level-3).

In one embodiment, the first threshold amount may be predetermined and also called as a promotion line between the first game level and the second game level or a level dividing line therebetween.

For example, the threshold amount for promotion in a higher level may be a fixed multiple of the threshold amount for promotion in a lower level. In particular, assuming that an initial chip amount that a new player (a Level-1 player) has is 1,000 chips, the threshold amount for promotion from Level-1 to Level-2 may be set to 10,000, the threshold amount for promotion from Level-2 to Level-3 may be set to 100,000, the threshold amount for promotion from Level-3 to Level-4 may be set to 1,000,000, and so on.

Alternatively, the higher the game level is, the much larger the multiple between the threshold amount for promotion in a higher level and the threshold amount for promotion in a lower level may be. In particular, assuming that an initial chip amount that a new player (a Level-1 player) has is 1,000 chips, the threshold amount for promotion from Level-1 to Level-2 may be set to 10,000 (the multiple is 10,000/1,000=10), the threshold amount for promotion from Level-2 to Level-3 may be set to 1,000,000 (the multiple is 1,000,000/10,000=100), and so on. By doing so, it becomes more difficult for higher level players to get promotion, so that experienced players can be accurately distinguished from novice players in higher level games, thereby minimizing a risk that novice players may get promoted due to catching lucky breaks.

Further, In one embodiment, if there is an upper limit on the number of players in the second level game, the sub-step of promoting the player's game level from the first game level to the second game level in response to the first game level being not the final game level in step S140 may include: determining a total number of existing players having the second game level; and promoting the player's game level from the first game level to the second game level in response to the total number of existing players being less than a preset number. Otherwise, the first-game-level player may be directly promoted to become a second-game-level player.

In one embodiment, after the first-game-level player's is promoted to a higher level game, he/she may get a number of extra bonus chips in addition to the chip amount originally carried with him/her when the promotion happens. For example, when a Level-1 player is promoted to become a Level-2 player, he/she may get a bonus of 10,000 chips.

In the second case, in one embodiment, step S140 may include: determining whether the first game level is an initial game level in response to the second chip amount being less than a second threshold amount; and demoting the player's game level from the first game level to the second game level in response to the first game level being not the initial game level, the second game level is one level lower than the first game level.

That is to say, if it is determined that the first game level is not the lowest game level in the multi-level tournament, and if the first-game-level player's chip amount exceeds a lower limit, he/she may be demoted to become a lower-game-level player. For example, a Level-3 player may be demoted to be a Level-2 player, or a Level-1 player (if the Level-1 player loses so many chips in one round that his/her chip amount directly goes beyond the threshold amount for demote to Level-1) or even eliminated (if the Level-1 player loses all of his chips in one round and cannot buy in or hasn't bought in any chips for a certain time period) in some rare occasion.

In one embodiment, the first threshold amount may be predetermined and also called as a demotion line between the first game level and the second game level.

For example, the threshold amount for demote from a higher level to a lower level may be the same as the threshold amount for promotion from the lower level to the higher level. In particular, assuming that an initial chip amount that a new player (a Level-1 player) has is 1,000 chips, the threshold amount for promotion from Level-1 to Level-2 is 10,000, the threshold amount for promotion from Level-2 to Level-3 is 100,000, the threshold amount for promotion from Level-3 to Level-4 is 1,000,000, and so on, the threshold amount for demotion from Level-2 to Level-1 may be set to 10,000, the threshold amount for demotion from Level-3 to Level-2 may be set to 100,000, the threshold amount for demotion from Level-4 to Level-3 may be set to 1,000,000, and so on.

Alternatively, the threshold amount for demote from a higher level to a lower level may be higher or lower than the threshold amount for promotion from the lower level to the higher level. Especially, in one embodiment, the second threshold amount may be equal to an average of total chip amounts that all players having the second game level have. In this case, the first threshold amount may also be called as an average chip line for the second game level. For example, the demotion of a higher level player may keep going level by level until his/her chip amount is equal to or more than the average chip line for a certain lower game level.

In the third case, in one embodiment, step S140 may include: remaining the player's game level unchanged in response to the second chip amount being less than the first threshold amount and equal to or more than the second threshold amount.

That is to say, if the first-game-level player's chip amount does not increase enough for promotion or decrease enough for demotion, he/she may be still remained as the first-game-level player.

After the player is promoted or demoted from the first game level to the second game level, the player may be forced to stop playing the first level game, leave the current game venue for first game level players, enter an existing game venue or a newly-created game venue for second game level players, and start to play the second level game with other second game level players. Alternatively, in case of promotion, a notification may be sent to the player so that he/she may select whether to advance to a next level game or to keep staying in the same level game.

Further, in addition to promoting a player's game level when his/her chip amount reaches or goes beyond a threshold amount for promotion, the player's game level may be promoted when a triggering event happens so as to ensure that there may be enough players existing and playing in a certain level game.

To this end, in one embodiment, the method for conducting a multi-level tournament may further include: determining a total number of existing players having the second game level in response to a predetermined trigger occurring, the second game level is one level higher than the first game level; determining N candidates having the most chip amounts from among all players having the first game level in response to the total number of existing players being less than a preset number, N being equal to the difference between the preset number and the total number of existing players; and promoting the candidates' game levels from the first game level to the second game level.

For example, if there are not enough players in a certain level game, existing players will have to keep waiting for other players to show up so as to conduct the game. Thus, in order to prevent the existing players from waiting for a very long time and to ensure that the multi-level tournament runs successfully, in one embodiment, a predetermined number of players having the most chip amounts in a lower level game may be automatically promoted to a higher level game after a certain time period from the beginning of the lower level game or the multi-level tournament even though they don't have enough chip amounts for promotion. In other word, the promotion on a player's game level may be triggered when a predetermined amount of time passes.

Alternatively, in case that blind levels increase at known intervals, the promotion may also be trigger when predetermined blind levels are reached. Further, the promotion on a first-game-level player's game level may also be triggered once a predetermined number of other first-game-level players in the same venue with him/her have been eliminated. It should be noted that other promotion triggers may be possible and are considered within the scope of the game.

Further, in addition to changing a player's chip amount according to the game result, the chip amount may be changed based on other factors such as the player's attendance in the multi-level tournament.

To this end, in one embodiment, the method for conducting a multi-level tournament may further include: determining the player's attendance in the multi-level tournament according to the player's profile, the profile further indicating a playtime in which the player conducts the multi-level tournament; changing the player's chip amount from the first chip amount to a third chip amount according to the player's attendance; and changing the player's game level from the first game level to a second game level in response to the third chip amount meeting the predetermined condition.

For example, each player's attendance may be checked at set intervals (e.g., every week). According to the statistics, for players haven't played in the multi-level tournament for a week, their chip amounts may be reduced by half; for players haven't played in the multi-level tournament for another two weeks, their chip amounts may be further reduced by half; and so it goes on until the players' chip amounts are plummeted to zero. With the reduction on players' chip amount, they may be re-classified into game levels corresponding to their current chip amounts. That is to say, players who haven't played in the multi-level tournament for a long time may be demoted and finally eliminated by de-escalation on their game levels.

Alternatively, a play's chip amount may also be changed based on a player's winning percentage, the time for completing his/her promotion, or the like. Also, a player may be allowed to directly buy in chips with cash, credit card, virtual coins, and so on.

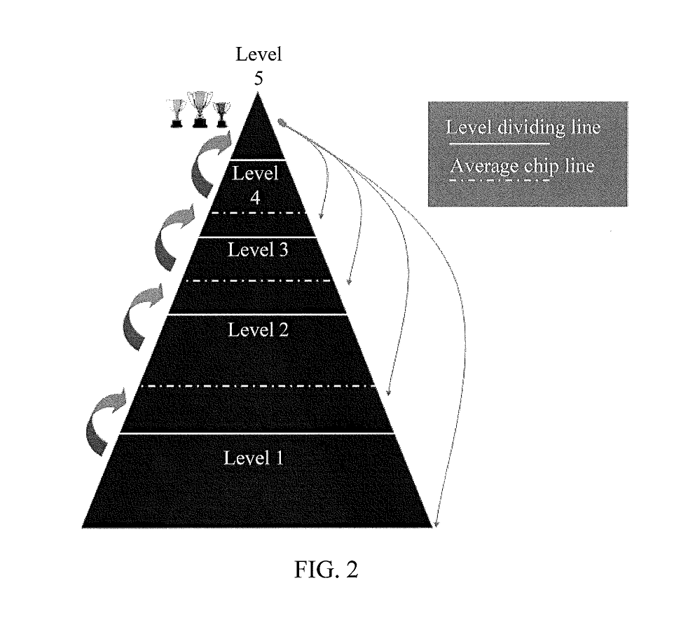

Hereinafter, a method for conducting a multi-level tournament according to the embodiments of the present application will be described with reference to FIGS. 2-4 in a particular example, in which it is assumed that the multi-level tournament is applied to the poker game of Texas hold'em in order to facilitate understanding. However, it should be noted that a variety of games such as board games including chess, go, checkers, etc., card games including Texas hold'em, Seven Card Stud, Low-Ball, Omaha and Draw Poker, etc., or combinations thereof may be adopted in the multi-level tournament.

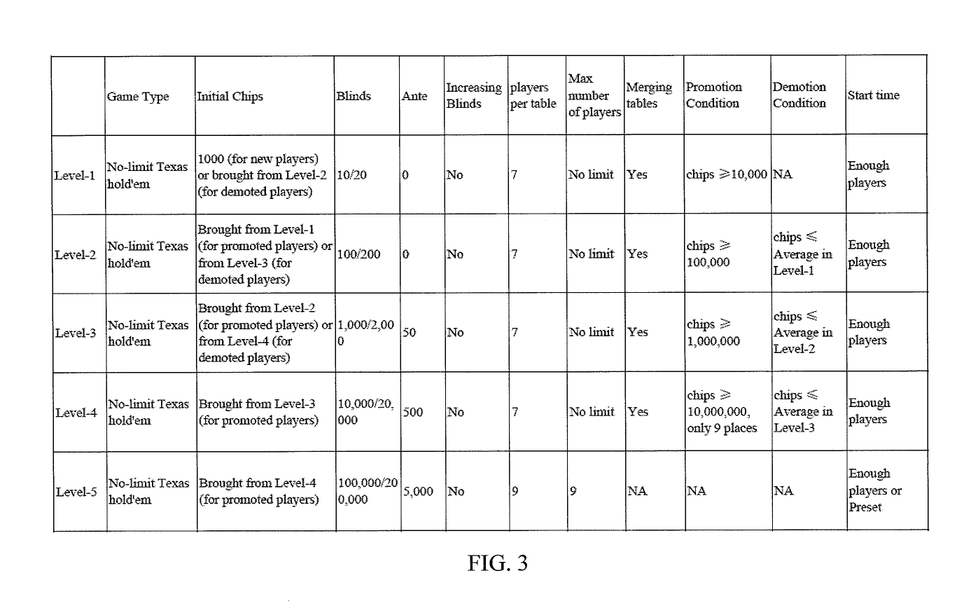

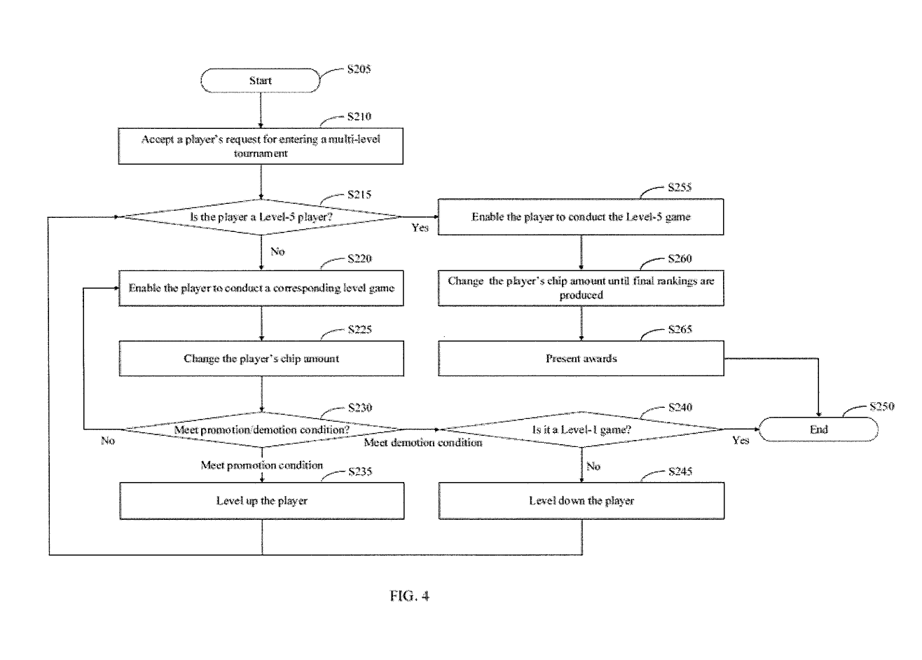

FIG. 2 is a schematic diagram showing an overall architecture of a multi-level tournament according to a particular example of one embodiment of the present application; FIG. 3 is a schematic diagram showing rules specified for each level of game in the multi-level tournament according to the particular example of one embodiment of the present application; and FIG. 4 is a flowchart depicting a method for conducting the multi-level tournament according to the particular example of one embodiment of the present application.

As shown in FIG. 2, it can be seen that, in the particular example, the multi-level tournament includes 5 levels of games in total, i.e., Level-1 game (also called as qualification trials), Level-2 (also called as preliminaries), Level-3 (also called as quarter-finals), Level-4 (also called as semi-finals), and Level-5 (also called as finals). Level-1 is an initial game level (i.e., the lowest level) and Level-5 is a final game level (i.e., the highest level). Herein, the term of “level” represents roughly a game skill of a player.

In the multi-level tournament, players are enabled to play games with others who have the same levels with them. During the games, players who keep winning other players' chips and have chips equal to or more than promotion thresholds (represented by level dividing lines between two adjacent levels in FIG. 2) may be promoted to corresponding higher level games. For example, Level-1 players may be promoted to Level-2, or even directly to Level-4 if they have enough chip amounts. In contrast, players who keep losing chips to others and have chips less than demotion thresholds (represented by average chip lines in FIG. 2) may be demoted to corresponding lower level games. For example, Level-4 players may be demoted to Level-3, or directly to Level-1 or even eliminated if they don't have enough chip amounts.

In the multi-level tournament, when lower level players become higher level players, they may get extra bonus chips for using in higher level games. Further, players who finally win Level-5 game may be presented awards such as medals, chips, and other stuffs, and players who lose all their chips may be kicked out of the tournament.

The multi-level tournament may be a tournament with a cycle. For example, the multi-level tournament may be conducted every week (e.g., from 0 o'clock Monday to 24 o'clock Sunday) and a set of final rankings are produced for each week so that awards can be presented accordingly.

In addition to the above rules specified for arranging the multi-level tournament, each level of game in the tournament may generally follow the previously-accepted rules used for Texas hold'em, an example of which is as shown in FIG. 3.

In one embodiment, the method can be carried out “in real life,” such as at a casino, with physical players, dealers, tables, cards, chips, etc. Additionally or alternatively, the method may be operable by one or more game servers.

Now, a general flow of a method for conducting the multi-level tournament according to the particular example of one embodiment of the present application will be described in detail with reference to FIG. 4.

As shown in FIG. 4, the multi-level tournament conducting method starts in step S205.

In step S210, a player's request for participation in the multi-level tournament is accepted. For example, at the beginning of the multi-level tournament, a player may select whether to enter the tournament as a new player or an existing player. If a player logs in as a new player, a profile is created at his/her registration in this tournament. A new player may be initialized as Level-1 player and assigned with a predetermined number of chips (1,000 chips as shown in FIG. 3). Each player's information such as an identification (ID), a password, a game level and a chip amount may be recorded in his/her newly-created profile and the profile may be stored in an internal or external database for future uses. If a player logs in as an existing player, his/her profile is acquired from the database according to the player's ID and information on the player's game level and chip amount is read from his/her profile.

In step S215, it is determined whether the player who logs in the tournament is a Level-5 player according to his/her profile. If this player is a Level-5 player, the method goes to step S255, otherwise the method goes to step S220.

First, assume that the player is a Level-1 player.

In step S220, the Level-1 player is enabled to play Texas hold'em with other Level-1 players. For example, the player is arranged to sit at a game table with the fewest players in a Level-1 game room to play Texas hold'em using rules specified for Level-1 game. As shown in FIG. 3, in Level-1 game, players can join the game at any time, there is no limit on the max number of players, 7 players are needed to play no-limit Texas hold'em at each table, each player either has an 1000 chips (in case of a newly-registered player) or a certain number of chips that he/she brings when being demoted from Level-2 (in case of a demoted player), the small and big blind bets are 10/20 and do not increase regularly, the ante is 0, and the game is conducted in a table merging mode, in which the number of players at each table is kept even by moving players, either by switching one player or (as the field shrinks) taking an entire table out of play and distributing its players amongst the remaining tables.

In step S225, the player's chip amount is continuously changed according to a result of each round of Level-1 game. For example, the player will have more chips if he/she wins and have fewer chips if he/she loses. The particular number of chips the player wins from or loses to other players depends on the betting in each round of the game.

In step S230, it is determined whether the play meets a promotion condition or a demotion condition in Level-1 game so as to decide whether the player shall be promoted to a higher level or demoted to a lower level or remained in the same level. When it is determined that the player has at least 10,000 chips, his/her game level may be promoted to a higher level game (e.g., Level-2) in step S235 and the corresponding information may be updated in his/her profile. When it is determined that the player has no chip, he/she may be kicked out of the tournament in step S250 and his/her profile may be deleted from the database after it is determined in step S240 that it is a Level-1 game for which there is no more lower level for demotion. Alternatively, before being kicked out, the player may be given an opportunity to restart the tournament by paying a buy-in or conducting an assigned task to get another 1,000 chips. When it is determined that the player has more than 0 and less than 10,000 chips, he/she may be remained in Level-1 to keep playing with others in step S220 until a promotion or a kicking-out happens.

After the Level-1 player is promoted to become a Level-2 player, the method returns to step S215 to determine whether the player is a Level-5 player according to his/her profile. Since this player is a Level-2 player, the method goes to step S220 once again.

In step S220, the Level-2 player is enabled to play Texas hold'em with other Level-2 players. For example, the player is arranged to sit at a game table with the fewest players in a Level-2 game room to play Texas hold'em using rules specified for Level-2 game. As shown in FIG. 3, in Level-2 game, players can join the game at any time, there is no limit on the max number of players, 7 players are needed to play no-limit Texas hold'em at each table, each player either has a certain number of chips that he/she brings when being or promoted from Level-1 (in case of a promoted player) or demoted from Level-3 (in case of a demoted player), the small and big blind bets are 100/200 and do not increase regularly, the ante is 0, and the game is conducted in the table merging mode.

In step S225, the player's chip amount is continuously changed according to a result of each round of Level-2 game.

In step S230, it is determined whether the play meets a promotion condition or a demotion condition in Level-2 game so as to decide whether the player shall be promoted to a higher level or demoted to a lower level or remained in the same level. When it is determined that the player has at least 100,000 chips, his/her game level may be promoted to a higher level game (e.g., Level-3) in step S235 and the corresponding information may be updated in his/her profile. When it is determined that the player has chips less than an average of total chips that all Level-1 players have, his/her game level may be demoted to a lower level game (e.g., Level-1) in step S245 and the corresponding information may be updated in his/her profile. When it is determined that the player has more than the average chip amount and less than 100,000 chips, he/she may be remained in Level-2 to keep playing with others in step S220 until a promotion or a demotion happens.

After the Level-2 player is promoted to become a Level-3 player or demoted to become a Level-1 player, the method returns to step S215 to determine whether the player is a Level-5 player according to his/her profile. The case for Level-1 player has been described in the above, thus only the description on the case for Level-3 player is presented. Since this player is a Level-3 player, the method goes to step S220 once again.

In step S220, the Level-3 player is enabled to play Texas hold'em with other Level-3 players. For example, the player is arranged to sit at a game table with the fewest players in a Level-3 game room to play Texas hold'em using rules specified for Level-3 game. As shown in FIG. 3, in Level-3 game, players can join the game at any time, there is no limit on the max number of players, 7 players are needed to play no-limit Texas hold'em at each table, each player either has a certain number of chips that he/she brings when being or promoted from Level-2 (in case of a promoted player) or demoted from Level-4 (in case of a demoted player), the small and big blind bets are 1,000/2,000 and do not increase regularly, the ante is 50, and the game is conducted in the table merging mode.

In step S225, the player's chip amount is continuously changed according to a result of each round of Level-3 game.

In step S230, it is determined whether the play meets a promotion condition or a demotion condition in Level-3 game so as to decide whether the player shall be promoted to a higher level or demoted to a lower level or remained in the same level. When it is determined that the player has at least 1,000,000 chips, his/her game level may be promoted to a higher level game (e.g., Level-4) in step S235 and the corresponding information may be updated in his/her profile. When it is determined that the player has chips less than an average of total chips that all Level-2 players have, his/her game level may be demoted to a lower level game (e.g., Level-2) in step S245 and the corresponding information may be updated in his/her profile. When it is determined that the player has more than the average chip amount and less than 1,000,000 chips, he/she may be remained in Level-3 to keep playing with others in step S220 until a promotion or a demotion happens.

After the Level-3 player is promoted to become a Level-4 player or demoted to become a Level-2 player, the method returns to step S215 to determine whether the player is a Level-5 player according to his/her profile. The case for Level-2 player has been described in the above, thus only the description on the case for Level-4 player is presented. Since this player is a Level-4 player, the method goes to step S220 once again.

In step S220, the Level-4 player is enabled to play Texas hold'em with other Level-3 players. For example, the player is arranged to sit at a game table with the fewest players in a Level-4 game room to play Texas hold'em using rules specified for Level-4 game. As shown in FIG. 3, in Level-4 game, players can join the game at any time, there is no limit on the max number of players, 7 players are needed to play no-limit Texas hold'em at each table, each player either has a certain number of chips that he/she brings when being or promoted from Level-3 (in case of a promoted player), the small and big blind bets are 1,000/2,000 and do not increase regularly, the ante is 500, and the game is conducted in the table merging mode.

In step S225, the player's chip amount is continuously changed according to a result of each round of Level-4 game.

In step S230, it is determined whether the play meets a promotion condition or a demotion condition in Level-4 game so as to decide whether the player shall be promoted to a higher level or demoted to a lower level or remained in the same level. When it is determined that the player has at least 10,000,000 chips and that there is at least one empty seat at the Level-5 table, his/her game level may be promoted to a higher level game (i.e., Level-5) in step S235 and the corresponding information may be updated in his/her profile. When it is determined that the player has chips less than an average of total chips that all Level-3 players have, his/her game level may be demoted to a lower level game (i.e., Level-3) in step S245 and the corresponding information may be updated in his/her profile. When it is determined that the player has more than the average chip amount and less than 10,000,000 chips, he/she may be remained in Level-4 to keep playing with others in step S220 until a promotion or a demotion happens.

Further, if the multi-level tournament has already been conducted for a week (that is to say, the time is up) and there are still not enough Level-4 players who have at least 10,000,000 chips to become Level-5 players, a certain number of Level-4 players who have the most chips may be preferably promoted to Level-5 so as to make sure that there are enough players in Level-5 game and the game can be conducted successfully. Alternatively, Level-5 game of this week may also be determined to be invalid or unavailable.

After the Level-4 player is promoted to become a Level-5 player or demoted to become a Level-3 player, the method returns to step S215 to determine whether the player is a Level-5 player according to his/her profile. The case for Level-3 player has been described in the above, thus only the description on the case for Level-4 player is presented. Since this player is a Level-5 player, the method goes to step S255.

In step S255, all of the Level-5 players are enabled to play Texas hold'em with each other. For example, the players are arranged to sit at one final game table to play Texas hold'em using rules specified for Level-5 game. As shown in FIG. 3, in Level-5 game, only 9 players are allowed to play no-limit Texas hold'em at the final game table, each player has a certain number of chips that he/she brings when being promoted from Level-4, the small and big blind bets are 100,000/200,000 and do not increase regularly, and the ante is 5,000.

For example, the Level-5 game may be conducted as soon as there are enough players promoted from Level-4 game. Alternatively, the Level-5 game may also be conduct at a preset time so as to attract more audiences to watch it. In the latter case, all of the Level-5 players may be given a ticket as a verification code for entering the Level-5 game after they are promoted from Level-4 game.

In step S260, the player's chip amount is continuously changed according to a result of each round of Level-5 game until final rankings are produced. For example, Level-5 players may be kicked out of the game one by one after losing all of their chips to other players until there is only one player in the game. The player remaining in the game is the champion of this multi-level tournament; the last player being kicked out of the game is the runner-up of this multi-level tournament; and the player being kicked out of the game right before the runner-up is the second runner-up of this multi-level tournament; and so on.

After the final rankings are produced, a certain number of Level-5 players (in case of example, top 3 players or all of the 9 players) may be presented awards such as medals, chips, colored diamonds (which are game tools for representing that the owner was once one of winners of the multi-level tournament. For example, one red diamond may be a representative of one time championship), and other stuffs.

Then, the method ends in step S250, which means that the multi-level tournament may finish after the award presentation. Alternatively, after S265, the method may return to step S210 to continue the multi-level tournament with a new round. In the latter case, in order to make sure that other players also have chance to edge into Level-5 game, before the new round of the multi-level tournament starts, the previously-awarded Level-5 players may be initialized as Level-1 player with only 1,000 chips or demoted to be other level players with a certain number of chips to restart their journey in the tournament.

In addition to the above-mentioned rules for the multi-level tournament, there may be other rules. For example, each player's attendance may be checked at set intervals (e.g., every week). According to the statistics, for players haven't played in the multi-level tournament for a week, their chip amounts may be reduced by half; for players haven't played in the multi-level tournament for another two weeks, their chip amounts may be further reduced by half; and so it goes on until the players' chip amounts are plummeted to zero. With the reduction on players' chip amount, they may be demoted to game levels corresponding to their current chip amounts. That is to say, players who haven't played in the multi-level tournament for a long time may be demoted and finally eliminated by de-escalation.

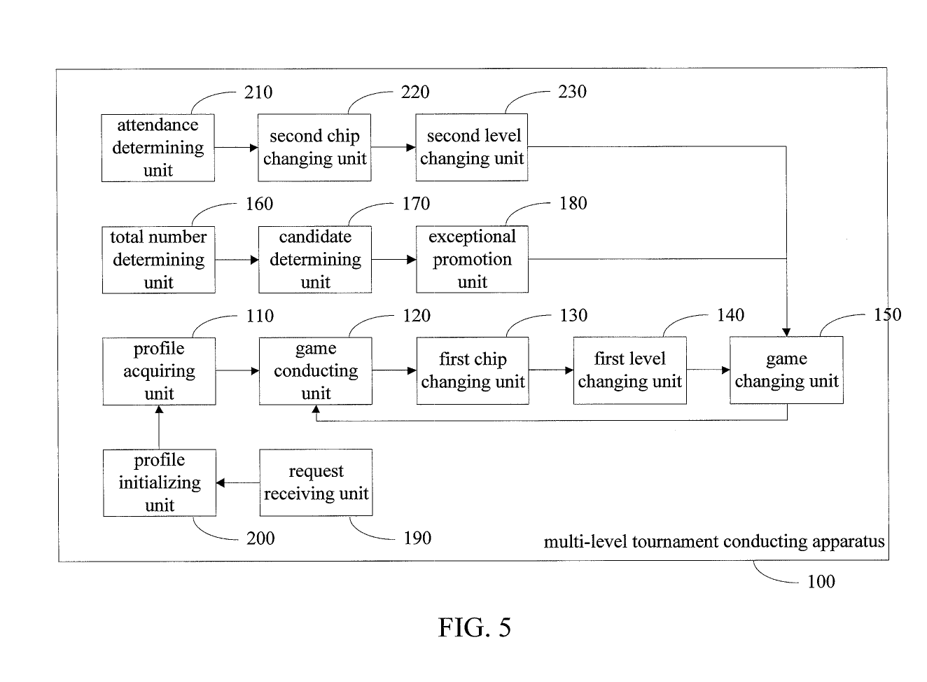

Hereinafter, an apparatus for conducting a multi-level tournament according to an embodiment of the present application will be described with reference to FIG. 5.

FIG. 5 is a block diagram depicting an apparatus for conducting a multi-level tournament according to one embodiment of the present application.

The method for conducting a multi-level tournament illustrated in FIG. 1 may be implemented by the apparatus for conducting a multi-level tournament 100 illustrated in FIG. 5. Since details of operations executed by this apparatus are the same as the steps in the method described above, in other words, respective details of the method described above also are applicable to this apparatus, only a brief description of the apparatus is provided herein and description about the same details is omitted.

As shown in FIG. 5, the apparatus for conducting a multi-level tournament 100 may include a profile acquiring unit 110, a game conducting unit 120, a first chip changing unit 130, a first level changing unit 140, and a game changing unit.

The profile acquiring unit 110 may be used for acquiring a player's profile from a database in response to the player entering the multi-level tournament, the profile indicating at least that the player has a first game level and a first chip amount.

The game conducting unit 120 may be used for enabling the player to conduct a first level game in response to the player having the first game level, the first level game being conducted among a plurality of players having the first game level.

The first chip changing unit 130 may be used for changing the player's chip amount from the first chip amount to a second chip amount according to a result of the first level game.

The first level changing unit 140 may be used for changing the player's game level from the first game level to a second game level in response to the second chip amount meeting a predetermined condition.

The game changing unit 150 may be used for enabling the player to exit the first level game and to conduct a second level game in response to the player's game level being changed from the first game level to the second game level.

In one embodiment, the game conducting unit 120 may enable the player to conduct a first level game in response to the player having the first game level by: checking whether an unoccupied place exists in an existing game venue for the first level game; adding the player into the existing game venue in response to the unoccupied place existing; and in response to the unoccupied place not existing, creating a new game venue for the first level game and adding the player into the new game venue.

In one embodiment, the first chip changing unit 130 may change the player's chip amount from the first chip amount to a second chip amount according to a result of the first level game by: enabling the player to wager in the first level game; and changing the player's chip amount from the first chip amount to a second chip amount according to the rule of the first level game, how all players in the first level game wager, and whether the player wins or loses the first level game.

In one embodiment, the first level changing unit 140 may change the player's game level from the first game level to a second game level in response to the second chip amount meeting a predetermined condition by: determining whether the first game level is a final game level in response to the second chip amount being equal to or more than a first threshold amount; and promoting the player's game level from the first game level to the second game level in response to the first game level being not the final game level, the second game level is one level higher than the first game level.

In particular, the first level changing unit 140 may promote the player's game level from the first game level to the second game level by: determining a total number of existing players having the second game level; and promoting the player's game level from the first game level to the second game level in response to the total number of existing players being less than a preset number.

In one embodiment, the first level changing unit 140 may change the player's game level from the first game level to a second game level in response to the second chip amount meeting a predetermined condition by: determining whether the first game level is an initial game level in response to the second chip amount being less than a second threshold amount; and demoting the player's game level from the first game level to the second game level in response to the first game level being not the initial game level, the second game level is one level lower than the first game level.

In particular, the second threshold amount may be equal to an average of total chip amounts that all players having the second game level have.

In one embodiment, the apparatus for conducting a multi-level tournament 100 may further include a total number determining unit 160, a candidate determining unit 170, and an exceptional promotion unit 180.

The total number determining unit 160 may be used for determining a total number of existing players having the second game level in response to a predetermined trigger occurring, the second game level is one level higher than the first game level.

The candidate determining unit 170 may be used for determining N candidates having the most chip amounts from among all players having the first game level in response to the total number of existing players being less than a preset number, N being equal to the difference between the preset number and the total number of existing players.

The exceptional promotion unit 180 may be used for promoting the candidates' game levels from the first game level to the second game level.

In one embodiment, the apparatus for conducting a multi-level tournament 100 may further include a request receiving unit 190 and a profile initializing unit 200.

The request receiving unit 190 may be used for receiving a request for entering the multi-level tournament from a new player.

The profile initializing unit 200 may be used for initializing the new player's profile according to the request so that the new player has an initial game level and an initial chip amount.

In one embodiment, the apparatus for conducting a multi-level tournament 100 may further include an attendance determining unit 210, a second chip changing unit 220, and a second level changing unit 230.

The attendance determining unit 210 may be used for determining the player's attendance in the multi-level tournament according to the player's profile, the profile further indicating a playtime in which the player conducts the multi-level tournament.

The second chip changing unit 220 may be used for changing the player's chip amount from the first chip amount to a third chip amount according to the player's attendance.

The second level changing unit 230 may be used for changing the player's game level from the first game level to a second game level in response to the third chip amount meeting the predetermined condition.

Although the above-mentioned units are taken as entities for perform the steps of the method for conducting a multi-level tournament according to embodiments of the present application, as will be appreciated by one skilled in the art, the multi-level tournament may be played in real life such as such as at a casino, with brick and mortar tables, cards, chips, etc., or played electronically on a networked gaming system such as a plurality of computers, including personal computers, mobile devices, etc., connected via the Internet and running similar software.

In the latter case, the tournament may utilize a system including a plurality of computers each having at least one display and input tools such as a keyboard, mouse, etc. Each computer may be in communication with a central computer (e.g., a game server) operatively connected to a database. The central computer may include software for running the tournament, e.g., calling a random number generator to determine what cards will be dealt to each player at each table, keeping track of player hands, wagers, winnings, losses, and monitoring and updating the status of the second stage trigger. With respect to “brick and mortar” tables, although play may be effectuated with traditional cards and chips, these system elements also may be incorporated in order to keep track of and record historical information relating to the tournament.

Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.” Furthermore, aspects of the present application may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program codes embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program codes embodied on a computer readable medium may be transmitted using any appropriate medium, including but not limited to wireless, wireline, optical fiber cable, RF, etc., or any suitable combination of the foregoing.

Computer program codes for carrying out operations for aspects of the present application may be written in any combination of one or more programming languages, including an object oriented programming language such as Java, Smalltalk, C++ or the like and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present application are described below with reference to flowchart illustrations and/or block diagrams of methods, apparatus (systems) and computer program products according to embodiments of the application. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

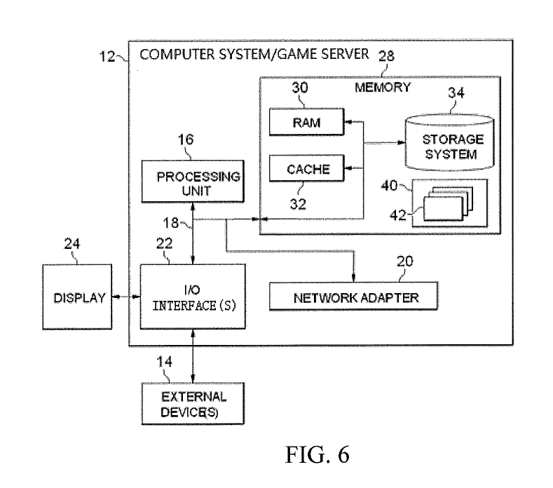

FIG. 6 is a block diagram depicting an exemplary computer system/game server which is applicable to implement the embodiments of the present application

Referring to FIG. 6, in which an exemplary computer system/game server 12 which is applicable to implement the embodiments of the present application is shown. The computer system/game server 12 is only illustrative and is not intended to suggest any limitation as to the scope of use or functionality of embodiments of the application described herein.

As shown in FIG. 6, the computer system/game server 12 is shown in the form of a general-purpose computing device. The components of the computer system/game server 12 may include, but are not limited to, one or more processors or processing units 16, a system memory 28, and a bus 18 that couples various system components including the system memory 28 to the processor 16.

The bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system/game server 12 typically includes a variety of computer system readable media. Such media may be any available media that is accessible by the computer system/game server 12, and it includes both volatile and non-volatile media, removable and non-removable media.

The system memory 28 can include computer system readable media in the form of volatile memory, such as random access memory (RAM) 30 and/or cache memory 32. The computer system/game server 12 may further include other removable/non-removable, volatile/non-volatile computer system storage media. By way of example only, a storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 18 by one or more data media interfaces. As will be further depicted and described below, the memory 28 may include at least one program product having a set (e.g., at least one) of program modules that are configured to carry out the functions of embodiments of the application.

The program/utility 40, having a set (at least one) of program modules 42, may be stored in the memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the application as described herein.

The computer system/game server 12 may also communicate with one or more external devices 14 such as a keyboard, a pointing device, a display 24, etc.; one or more devices that enable a user to interact with the computer system/game server 12; and/or any devices (e.g., network card, modem, etc.) that enable the computer system/game server 12 to communicate with one or more other computing devices. Such communication can occur via Input/Output (I/O) interfaces 22. Still yet, the computer system/game server 12 can communicate with one or more networks such as a local area network (LAN), a general wide area network (WAN), and/or a public network (e.g., the Internet) via a network adapter 20. As depicted, the network adapter 20 communicates with the other components of the computer system/game server 12 via the bus 18. It should be understood that although not shown, other hardware and/or software components could be used in conjunction with the computer system/game server 12. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present application. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present application have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for conducting a multi-level tournament performed by a game server, comprising:
acquiring a player's profile from a database in response to said player entering said multi-level tournament, said profile indicating at least that said player has a first game level and a first chip amount;
enabling said player to conduct a first level game in response to said player having said first game level, said first level game being conducted among a plurality of players having said first game level;
changing said player's chip amount from said first chip amount to a second chip amount according to a result of said first level game;
changing said player's game level from said first game level to a second game level in response to said second chip amount meeting a predetermined condition; and
enabling said player to exit said first level game and to conduct a second level game in response to said player's game level being changed from said first game level to said second game level.

2. The method of claim 1, wherein enabling said player to conduct a first level game in response to said player having said first game level comprises:
checking whether an unoccupied place exists in an existing game venue for said first level game;
adding said player into said existing game venue in response to said unoccupied place existing; and
in response to said unoccupied place not existing, creating a new game venue for said first level game and adding said player into said new game venue.

3. The method of claim 1, wherein changing said player's chip amount from said first chip amount to the second chip amount according to a result of said first level game comprises:
enabling said player to wager in said first level game; and
changing said player's chip amount from said first chip amount to the second chip amount according to a rule of said first level game, how all players in said first level game wager, and whether said player wins or loses said first level game.

4. The method of claim 1, wherein changing said player's game level from said first game level to the second game level in response to said second chip amount meeting the predetermined condition comprises:
determining whether said first game level is a final game level in response to said second chip amount being equal to or more than a first threshold amount; and
promoting said player's game level from said first game level to said second game level in response to said first game level being not said final game level, said second game level being one level higher than said first game level.

5. The method of claim 4, wherein promoting said player's game level from said first game level to said second game level comprises:
determining a total number of existing players having said second game level; and
promoting said player's game level from said first game level to said second game level in response to said total number of existing players being less than a preset number.

6. The method of claim 1, wherein changing said player's game level from said first game level to the second game level in response to said second chip amount meeting the predetermined condition comprises:
determining whether said first game level is an initial game level in response to said second chip amount being less than a second threshold amount; and
demoting said player's game level from said first game level to said second game level in response to said first game level being not said initial game level, said second game level being one level lower than said first game level.

7. The method of claim 6, wherein said second threshold amount is equal to an average of total chip amounts of all players having said second game level.

8. The method of claim 1, further comprising:
determining a total number of existing players having said second game level in response to a predetermined trigger occurring, said second game level being one level higher than said first game level;
determining N candidates having the most chip amounts from among all players having said first game level in response to said total number of existing players being less than a preset number, N being equal to a difference between said preset number and said total number of existing players; and
promoting said candidates' game levels from said first game level to said second game level.

9. The method of claim 1, further comprising:
receiving a request for entering said multi-level tournament from a new player; and
initializing said new player's profile according to said request so that said new player has an initial game level and an initial chip amount.

10. The method of claim 1, further comprising:
determining said player's attendance in said multi-level tournament according to said player's profile, said profile indicating a playtime in which said player conducts said multi-level tournament;
changing said player's chip amount from said first chip amount to a third chip amount according to said player's attendance; and
changing said player's game level from said first game level to the second game level in response to said third chip amount meeting said predetermined condition.

11. A game server for conducting a multi-level tournament, comprising at least a processor operating in conjunction with a memory and a plurality of units, which units comprising:
a profile acquiring unit for acquiring a player's profile from a database in response to said player entering said multi-level tournament, said profile indicating at least that said player has a first game level and a first chip amount;
a game conducting unit for enabling said player to conduct a first level game in response to said player having said first game level, said first level game being conducted among a plurality of players having said first game level;
a first chip changing unit for changing said player's chip amount from said first chip amount to a second chip amount according to a result of said first level game;
a first level changing unit for changing said player's game level from said first game level to a second game level in response to said second chip amount meeting a predetermined condition; and
a game changing unit for enabling said player to exit said first level game and to conduct a second level game in response to said player's game level being changed from said first game level to said second game level.

12. The game server of claim 11, wherein said game conducting unit enables said player to conduct a first level game in response to said player having said first game level by:
checking whether an unoccupied place exists in an existing game venue for said first level game;
adding said player into said existing game venue in response to said unoccupied place existing; and
in response to said unoccupied place not existing, creating a new game venue for said first level game and adding said player into said new game venue.

13. The game server of claim 11, wherein said first chip changing unit changes said player's chip amount from said first chip amount to the second chip amount according to the result of said first level game by:
enabling said player to wager in said first level game; and
changing said player's chip amount from said first chip amount to the second chip amount according to a rule of said first level game, how all players in said first level game wager, and whether said player wins or loses said first level game.

14. The game server of claim 11, wherein said first level changing unit changes said player's game level from said first game level to the second game level in response to said second chip amount meeting the predetermined condition by:
determining whether said first game level is a final game level in response to said second chip amount being equal to or more than a first threshold amount; and
promoting said player's game level from said first game level to said second game level in response to said first game level being not said final game level, said second game level being one level higher than said first game level.

15. The game server of claim 14, wherein said first level changing unit promotes said player's game level from said first game level to said second game level by:
determining a total number of existing players having said second game level; and
promoting said player's game level from said first game level to said second game level in response to said total number of existing players being less than a preset number.

16. The game server of claim 11, wherein said first level changing unit changes said player's game level from said first game level to the second game level in response to said second chip amount meeting the predetermined condition by:
determining whether said first game level is an initial game level in response to said second chip amount being less than a second threshold amount; and
demoting said player's game level from said first game level to said second game level in response to said first game level being not said initial game level, said second game level being one level lower than said first game level.

17. The game server of claim 16, wherein said second threshold amount is equal to an average of total chip amounts of all players having said second game level.

18. The game server of claim 11, further comprising:
a total number determining unit for determining a total number of existing players having said second game level in response to a predetermined trigger occurring, said second game level being one level higher than said first game level;
a candidate determining unit for determining N candidates having the most chip amounts from among all players having said first game level in response to said total number of existing players being less than a preset number, N being equal to a difference between said preset number and said total number of existing players; and
an exceptional promotion unit for promoting said candidates' game levels from said first game level to said second game level.

19. The game server of claim 11, further comprising:
a request receiving unit for receiving a request for entering said multi-level tournament from a new player; and
a profile initializing unit for initializing said new player's profile according to said request so that said new player has an initial game level and an initial chip amount.

20. The game server of claim 11, further comprising:
an attendance determining unit for determining said player's attendance in said multi-level tournament according to said player's profile, said profile indicating a playtime in which said player conducts said multi-level tournament;
a second chip changing unit for changing said player's chip amount from said first chip amount to a third chip amount according to said player's attendance; and
a second level changing unit for changing said player's game level from said first game level to the second game level in response to said third chip amount meeting said predetermined condition.

21. A computer program product comprising program codes for performing the following steps when the computer program codes are executed on one or more computing devices:
acquiring a player's profile from a database in response to said player entering said multi-level tournament, said profile indicating at least that said player has a first game level and a first chip amount;
enabling said player to conduct a first level game in response to said player having said first game level, said first level game being conducted among a plurality of players having said first game level;
changing said player's chip amount from said first chip amount to a second chip amount according to a result of said first level game;
changing said player's game level from said first game level to a second game level in response to said second chip amount meeting a predetermined condition; and
enabling said player to exit said first level game and to conduct a second level game in response to said player's game level being changed from said first game level to said second game level.

22. The computer program product according to claim 21, stored on a non-transitory computer readable recording medium.
